(19) United States
(12) Patent Application Publication
(10) Pub. No.: US 2014/0188482 A1
(43) Pub. Date: Jul. 3, 2014

(54) VOICE CONTROL METHOD, DEVICE, AND RECORDING MEDIUM FOR THE SAME

(71) Applicant: INDUSTRIAL TECHNOLOGY RESEARCH INSTITUTE, (US)

(72) Inventors: Hsin-Chang Chang, Changhua County (TW); Jia-Jang Tu, Hsinchu City (TW); Jian-Yung Hung, Taipei City (TW); Chih-Chung Kuo, Hsinchu County (TW)

(73) Assignee: INDUSTRIAL TECHNOLOGY RESEARCH INSTITUTE, Hsinchu (TW)

(21) Appl. No.: 13/872,188

(22) Filed: Apr. 29, 2013

(30) Foreign Application Priority Data
Dec. 28, 2012 (TW) 101151139

(51) Int. Cl. G10L 21/00

(52) U.S. Cl. CPC G10L 21/00
USPC 704/275

(57) ABSTRACT

A voice control method is provided. At least one object name-action prompt correspondence document is received and processed into an object name-action prompt correspondence document set that defines at least one object name and at least one corresponding action prompt. The object name-action prompt correspondence document set is processed to establish an object name-action prompt correspondence list. A voice is recognized as one or multiple voice recognition results to generate one or multiple corresponding candidate object names. At least one corresponding candidate action prompt is outputted according to the candidate object name(s) and the object name-action prompt correspondence list. A selected action prompt is received, and a module providing the selected action prompt is requested to execute an operation.

### CROSS-REFERENCE TO RELATED APPLICATION

This application claims the benefit of Taiwan application Serial No. 101151139, filed Dec. 28, 2012, the disclosure of which is incorporated by reference herein in its entirety.

### TECHNICAL FIELD

The disclosure relates to a voice control method, a device, a recording medium for the same.

### BACKGROUND

Portable devices, e.g., portable handsets (more particularly smart portable handsets) and portable pads, are indispensables in the daily life. Portable handsets/pads are controlled and operated through keys and/or touch control. However, the ease of use of the above portable devices may be further enhanced if the portable devices could be operated through voice control.

Voice control is currently implemented on portable handsets through various approaches. For example, voice control could be implemented through a hierarchical design, a single-layer (a single interface) design, or large vocabulary continuous speech recognition.

In a hierarchical design, applications with a voice recognition function support voice control. After selecting an application supporting voice recognition, a user may send a voice instruction to control the application. For such type of design, developers of applications develop the voice recognition function, and users correspondingly learn operation processes of different applications one after another.

A single-layer design employs a single interface, through which all applications share the same voice recognition software. After selecting the single interface, a user speaks a particular voice instruction and an object name. For example, assuming that a voice instruction format of the application is “bus enquiry”+“destination”, the application could be correctly operated if the voice input is “bus enquiry Taipei”. On the other hand, if the voice input is “bus search Taipei” or “Taipei bus enquiry”, the application may not be correctly operated as the voice instruction format is not satisfied.

With respect to large vocabulary continuous speech recognition, taking “Siri” developed by Apple Computer, Inc. for example, voice control could be implemented by a voice instruction spoken in a colloquial manner. For such type of voice control, an application is not required to support a voice recognition function, nor is a user demanded to memorize special voice instructions.

The disclosure is directed to a voice control method, device, and recording medium for the same.

### SUMMARY

According to one exemplary embodiment, a voice control method is provided. At least one object name-action prompt correspondence document is received and processed into an object name-action prompt correspondence document set that defines at least one object name and at least one corresponding action prompt. The object name-action prompt correspondence document set is processed to establish an object name-action prompt correspondence list. A voice is recognized as one or multiple voice recognition results to generate one or multiple corresponding candidate object names. At least one corresponding candidate action prompt is outputted according to the candidate object name(s) and the object name-action prompt correspondence list. A selected action prompt is received, and a module providing the selected action prompt is requested to execute an operation.

According to another exemplary embodiment, a voice control device is provided. The voice control device includes an object name-action prompt correspondence document set processing module, an object name combining module, a voice recognition module and an action prompt output module. The object name-action prompt correspondence document set processing module receives and processes at least one object name-action prompt correspondence document into an object name-action prompt correspondence document set. The object name-action prompt correspondence document defines at least one object name and at least one corresponding action prompt. The object name combining module processes the object name-action prompt correspondence document set to establish an object name-action prompt correspondence list. The voice recognition module recognizes a voice as one or multiple voice recognition results to generate one or multiple candidate object names. The action prompt output module outputs at least one corresponding action prompt according to the candidate object name(s) and the object name-action prompt correspondence list. The action prompt output module further receives a selected action prompt, and requests a module providing the selected action prompt to execute an operation.

According to an alternative embodiment, a computer-readable recording medium is provided. When the computer-readable recording medium is read by a device, the device performs the above voice control method.

### BRIEF DESCRIPTION OF THE DRAWINGS

FIG. 1 is a block diagram of a voice control device based on object name recognition according to one embodiment.

FIG. 2 is an example of an object name-action prompt correspondence document set according to one embodiment.

FIG. 3 is a schematic diagram of an object name combining module according to one embodiment.

FIG. 4 is a schematic diagram of an action prompt output according to one embodiment.

FIGS. 5A and 5B are flowcharts of a voice control method based on object name recognition according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A system of a device (e.g., a handheld device such as a smart portable handset or a portable pad) combines a corresponding relationship between an “object name” and an “action prompt” provided by at least one application to sort out “action prompts” corresponding to the same “object name”. When a user speaks the “object name”, the system recognizes the user speech through voice recognition and identifies a candidate object name, and provides the corresponding “action prompt” such as navigation, making a call, bus information and promotion information to the user for the user to select from. Thus, when operating the voice control, the user speaks an “object name” that is easily memorized and colloquial in the daily life.

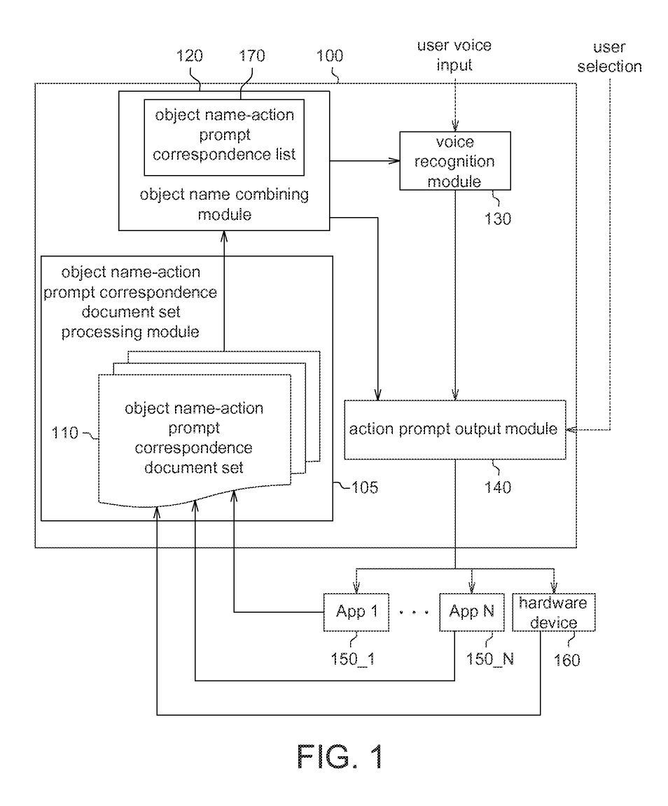

FIG. 1 shows a block diagram of a voice control device based on object name recognition according to one embodiment. As shown in FIG. 1, a voice control device 100 includes an object name-action prompt correspondence document set processing module 105, an object name combining module 120, a voice recognition module 130 and an action prompt output module 140.

The object name-action prompt correspondence document set processing module 105 receives and processes one or multiple object name-action prompt correspondence documents from at least one application App 1 150_1 to App N 150_N and/or at least one hardware device 160 into an object name-action prompt correspondence document set 110. The object name-action prompt correspondence documents define at least one object name and at least one corresponding action prompt. Throughout the disclosure, “at least one” represents one or plural. Details of the object name-action prompt correspondence documents are to be described below. Throughout the disclosure, “voice control based on object name recognition” means that the applications App 1 150_1 to App N 150_N and the hardware device 160 may share the object name-action prompt correspondence document set processing module 105, the object name combining module 120, the voice recognition module 130 and the action prompt output module 140 in FIG. 1. Further, the system may provide a voice control interface to the applications App 1 150_1 to App N 150_N and the hardware device 160, so as to allow the user to control the applications App 1 150_1 to App N 150_N and the hardware device 160 through the voice control interface by voice.

For an object name, the object name combining module 120 combines at least one object name-action prompt correspondence document in the object name-action correspondence document set 110 to find out and combine all corresponding action prompts corresponding to the object name. The object name combining module 120 further combines object names in the object name-action prompt correspondence document set 110 to combine at least one action prompt corresponding to the same object name, so as to establish an object name-action prompt correspondence list 170. In other words, the object name combining module 120 finds out and combines one or multiple action prompts corresponding to the same object name from the object name-action prompt correspondence document set 110 to establish the object name-action prompt correspondence list 170. In the object name-action prompt correspondence list 170, each object name appears once and corresponds to at least one action prompt. The object name combining module 120 may perform the above operations on all object names.

The voice recognition module 130 recognizes the user speech to generate a voice recognition result, and performs precise comparison or fuzzy comparison on the object names in the object name-action prompt correspondence list 170 to identify a corresponding candidate object name.

According to the object name-action prompt correspondence list 170, the action prompt output module 140 finds out one or multiple candidate action prompts corresponding to the candidate object name from the object name-action prompt correspondence list 170, and provides one or multiple candidate action prompts to the user to allow the user to select an operation. After the user selects the operation, the action prompt output module 140 activates an associated application and/or hardware device according to the user selection, to request the application and/or hardware device to execute an associated operation.

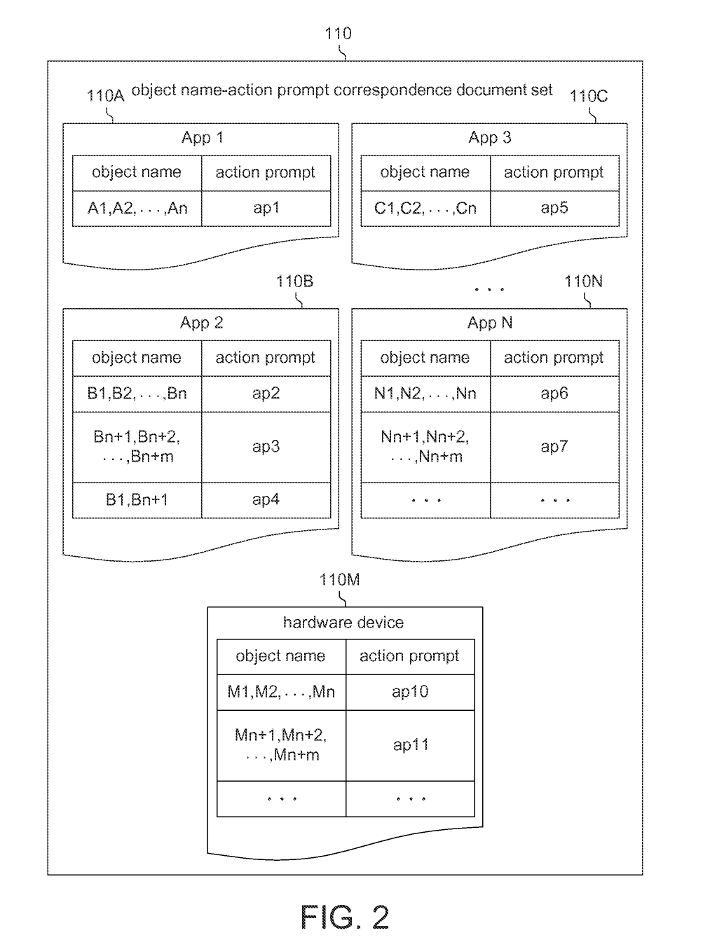

FIG. 2 shows an example of the object name-action prompt correspondence document set 110 according to one embodiment. In an object name-action prompt correspondence document 110A provided by the application App 1 150_1, object names A1 to An correspond to an action prompt ap1. More specifically, with respect to the application App 1 150_1, the application App 1 150_1 provides the action prompt ap1 if the identified object name is one of the object names A1 to An.

Similarly, in an object name-action prompt correspondence document 110B provided by the application App 2 150_2, object names B1 to Bn correspond to an action prompt ap2, object names Bn+1 to Bn+m correspond to an action prompt ap3, and object names B1 and Bn+1 correspond to an action prompt ap4. That is to say, in one embodiment, one object name may correspond to one or multiple action prompts, whereas one action prompt may correspond to one or multiple object names.

In an object name-action prompt correspondence document 110c provided by the application App 3 150_3, object names C1 to Cn correspond to an action prompt ap5. In an object name-action prompt correspondence document 110N provided by the application App N 150_N, object names N1 to Nn correspond to an action prompt ap6, and object names Nn+1 to Nn+m correspond to an action prompt ap7.

In an object name-action prompt correspondence document 110M provided by the hardware device 160, object names M1 to Mn correspond to an action prompt ap10, and object names Mn+1 to Mn+m correspond to an action prompt ap11.

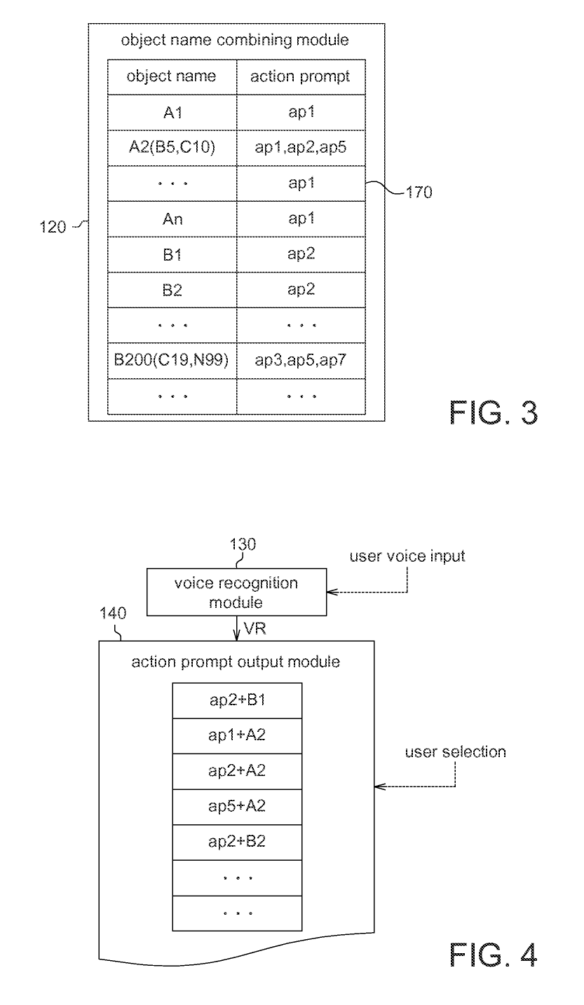

FIG. 3 shows a schematic diagram of the object name combining module 120 according to one embodiment. For each object name, the object name combining module 120 processes and combines all the corresponding action prompts to establish the object name-action prompt correspondence list 170. As shown in FIGS. 2 and 3, the object names A2, B5 and C10 are the same (A2=B5=C10), and the object names A2, B5 and C10 respectively correspond to action prompts ap1, ap2 and ap5. Therefore, the object name combining module 120 performs a combining process to obtain that the action prompts corresponding to the object name (A2=B5=C10) are ap1, ap2 and ap5.

For example, for an object name “Michael Jackson”, assume that action prompts provided by an application are “artist” and “album”, and an action prompt provided by another application is “special events”. After the combining process performed by the object name combining module 120, the object name “Michael Jackson” corresponds to the action prompts “artist”, “album” and “special events”.

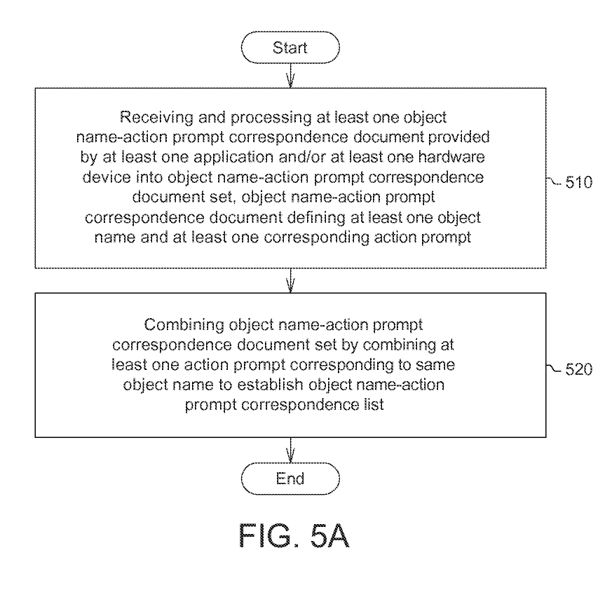

FIG. 4 shows a schematic diagram of an action prompt output according to one embodiment. As shown in FIG. 4, after receiving a user voice input, the voice recognition module 130 performs voice recognition to obtain a voice recognition result VR, and compares the voice recognition VR with the object name-action prompt correspondence list 170 to identify the candidate object name. For example, assume that the voice recognition result VR includes three candidate object names B1, A2 and B2. The action prompt output module 140 compares the candidate object names with the object name-action prompt correspondence list 170 established by the object name combining module 120, obtains the action prompts corresponding to the candidate object names, and outputs the obtained corresponding action prompts to the user. For example, assume that the object name B1 corresponds to the action prompt ap2, the object name A2 corresponds to the action prompts ap1, ap2 and ap5, and the object name B2 corresponds to the action prompt ap2. The system then outputs combinations of the object names and action prompts ap2+B1, ap1+A2, ap2+A2, ap5+A2 and ap2+B2 to the user for user selection. After user selection, the action prompt output module 140 requests an associated module, which may be an application and/or hardware device, to perform an associated operation and/or function. For example, the user makes the user selection by pressing a key of the device, by touching a control panel, or by speaking out the user selection.

An example is given below for explaining operation details of FIG. 4. For example, the voice recognition VR includes three candidate answers (object names)—“Taipei 101”, “Taipei Train Station” and “Taipei Zoo”. After inquiring a combined result of object names of the object name combining module 120, the action prompts corresponding to the three candidate object names are “Today's special events at Taipei 101”, “Today's weather at Taipei 101”, “Navigating to Taipei 101”, “Navigating to Taipei Train Station”, and “Navigating to Taipei Zoo” for the user to select from.

Further, in one embodiment, the number of action prompts as well as the combinations and arrangements of the object names and action prompts listed by the action prompt output module 140 may be adjusted according to actual requirements of the device/system.

An exemplifying complete process of one embodiment is described below. A user voice input “Taipei 101” is entered. The system performs voice recognition and identifies the object name “Taipei 101”. For example, the voice recognition is performed by the voice recognition module 130. The action prompt output module 140 outputs action prompts associated with “Taipei 101”—“bus enquiry”, “event search”, “location” and “weather”, as options for the user to select from. In one embodiment, as long as the user is easy to learn the action prompts currently outputted by the system, the output of the action prompt output module 140 may be in form of texts, graphics or speech playbacks. Assuming that the user selects “weather at Taipei 101”, it means that the user wishes to know the weather within proximity of Taipei 101, and so the system automatically activates a weather forecast application. The application then decides information to be outputted to the user. For example, the weather forecast application displays “Taipei 101: temperature 25˜30° C., chances of rain: 90%”, voice broadcasts “Taipei 101: temperature 25˜30° C., chances of rain: 90%”, or voice broadcasts “Taipei 101: temperature 25˜30° C., chances of rain: 90%, typhoon forecasted tomorrow, estimated land typhoon alert issue time: 1:00 am”.

That is to say, from the above embodiment, it is demonstrated that the user is not required to initiatively select an application to be activated before voice input. More specifically, the system recognizes the object name in the voice input, and the action prompts associated with the object name are outputted by the system to the user for the user to select from. The selected action prompt is then provided by the system to an application/hardware device to request the application/hardware device to execute the corresponding operation and/or function.

In the above embodiment, the user controls the application through voice control. In an alternative embodiment, a user may also control a hardware device through voice control. Assume that a user wishes to turn on the television to watch a television program “Chic Eats”. The user may first enter a voice input “Chic Eats”, which is recognized by the system, e.g., by a voice recognition module. The system then lists the action prompts associated with “Chic Eats”, e.g., “channel selection” (e.g., provided by a television hardware device), “television program introduction” (e.g., provided by a television program introduction application), and “gourmet map” (e.g., provided by a gourmet map application) for the user to select from. For example, the above step is performed by an action prompt output module. Next, the user selects the action prompt “play television program Chic Eats”. After receiving the user selection, the system activates the “television”, and the television displays information, e.g., the television plays/switches to the television program “Chic Eats”.

In the above example, the television (hardware device) provides an object name-action prompt correspondence document (e.g., “Chic Eats”—“play television program”) to the system. The system accordingly establishes a document set and combines object names, as previously described.

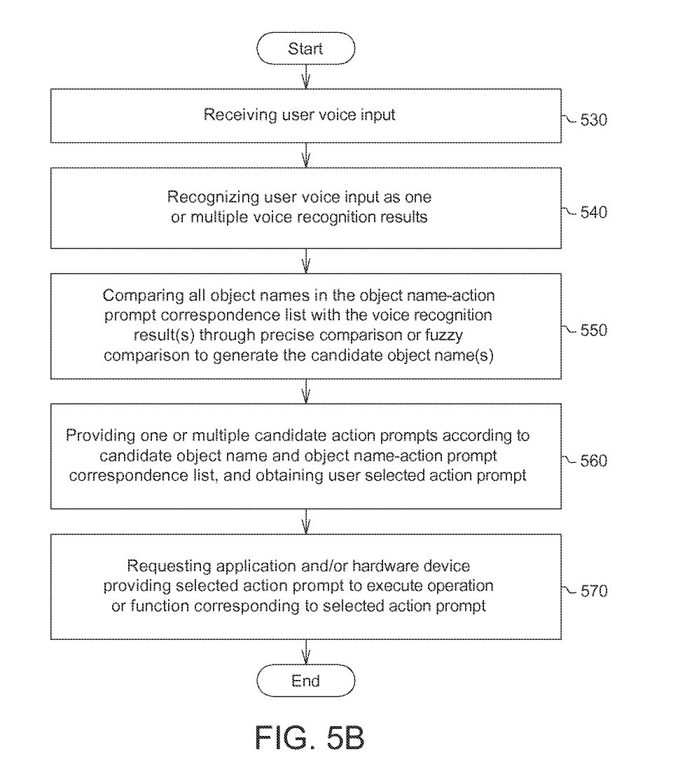

FIGS. 5A and 5B are flowcharts of a voice control method based on object name recognition according to one embodiment. FIG. 5A shows details for establishing the object name-action prompt correspondence document list 170 according to one embodiment; and FIG. 5B shows details for executing voice control according to one embodiment.

As shown in FIG. 5A, in step 510, at least one object name-action prompt correspondence document provided by at least one application and/or at least one hardware device is received and processed into an object name-action prompt correspondence document set. The object name-action prompt correspondence document defines at least one object name and at least one corresponding action prompt.

In step 520, the object names in the object name-action prompt correspondence document set are combined by combining at least one action prompt corresponding to the same object name to establish an object name-action prompt correspondence list.

As shown in FIG. 5B, in step 530, user voice input is received. In step 540, the user voice input is recognized to output one or multiple voice recognition results. In step 550, all object names in the object name-action prompt correspondence list are compared with the voice recognition result(s) through precise comparison or fuzzy comparison to generate the candidate object name(s).

In step 560, one or multiple candidate action prompts are provided according to the candidate object name and the object name-action prompt correspondence list, and an action prompt selected by the user is obtained. In step 570, the application and/or hardware device provided with the selected action prompt is requested to execute an operation and/or function corresponding to the action prompt.

Details of steps 510 to 570 are as previously described, and shall be omitted herein.

A computer-readable recording medium is further provided according to one embodiment. When the computer-readable recording medium is read by a device, the device performs the above voice control method. Associated details could be referred from the foregoing embodiments, and shall be omitted herein.

A computer program product is provided according to yet another embodiment. When the computer program product is loaded by a one or multiple devices, the device(s) is/are capable of performing the above voice control method. Associated details could be referred from the foregoing embodiments, and shall be omitted herein.

With the described embodiments, it is demonstrated that, instead of additionally memorizing diversified formats and syntax of particular voice instructions, a user speaks out an “object name” in voice control, thereby may reduce mental encumbrance for the user. The user is then able to instruct the system to automatically execute a corresponding application and/or hardware device by simply selecting an action prompt from action prompts visually or aurally perceived.

Since the system provides a voice recognition input interface and a software/hardware developer provides object names and action prompt correspondence documents, the software/hardware developer is not required to provide a voice recognition function in the application and/or hardware device, thereby lowering a barrier of a voice control function supported by the software/hardware developer.

Further, from perspectives of a system developer, the embodiments provide a single voice control window that could be utilized by an application/hardware developer. The technical complications and difficulties are also lowered for the system developer.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A voice control method, comprising:
receiving and processing at least one object name-action prompt correspondence document into an object name-action prompt correspondence document set;
processing the object name-action prompt correspondence document set to establish an object name-action prompt correspondence list;
recognizing a voice as one or a plurality of voice recognition results to generate one or a plurality of candidate object names;
outputting at least one corresponding candidate action prompt according to the candidate object name(s) and the object name-action prompt correspondence list; and
receiving a selected action prompt, and requesting a module providing the selected action prompt to execute an operation.

2. The voice control method according to claim 1, the at least one object name-action prompt correspondence document defines at least one object name and at least one corresponding action prompt.

3. The voice control method according to claim 2, wherein the module is an application or a hardware device.

4. The voice control method according to claim 3, wherein at least one action prompt corresponding to a same object name is fetched from the object name-action prompt correspondence document set to establish the object name-action prompt correspondence list, and each of the object names in the object name-action prompt correspondence list is unique and corresponds to one or a plurality of action prompts.

5. The voice control method according to claim 3, wherein the object name-action prompt correspondence document set comprises respective individual object name-action prompt correspondence documents provided by respective applications or respective hardware devices.

6. The voice control method according to claim 3, wherein all object names in the object name-action prompt correspondence list are compared with the voice recognition result(s) through precise comparison or fuzzy comparison to generate the candidate object name(s).

7. The voice control method according to claim 6, wherein the at least one corresponding candidate action prompts corresponding to the candidate object name(s) is/are identified from the object name-action prompt correspondence list.

8. The voice control method according to claim 1, wherein the voice is a user voice.

9. A voice control device, comprising:
an object name-action prompt correspondence document set processing module, for receiving and processing at least one object name-action prompt correspondence document into an object name-action prompt correspondence document set;
an object name combining module, for processing the object name-action prompt correspondence document set to establish an object name-action prompt correspondence list;
a voice recognition module, for recognizing a voice as one or a plurality of voice recognition results to generate one or a plurality of candidate object names; and
an action prompt output module, for outputting at least one corresponding candidate action prompt according to the candidate object name(s) and the object name-action prompt correspondence list, receiving a selected action prompt, and requesting a module providing the selected action prompt to execute an operation.

10. The voice control device according to claim 9, wherein the at least one object name-action prompt correspondence document defines at least one object name and at least one corresponding action prompt.

11. The voice control device according to claim 10, wherein the module is an application or a hardware device.

12. The voice control device according to claim 11, wherein the object name combining module fetches and combines at least one action prompt corresponding to a same object name from the object name-action prompt correspondence document set to establish the object name-action prompt correspondence list, and each of the object names in the object name-action prompt correspondence list is unique and corresponds to one or a plurality of action prompts.

13. The voice control device according to claim 11, wherein the object name-action prompt correspondence document set comprises respective individual object name-action prompt correspondence documents provided by respective applications or respective hardware devices.

14. The voice control device according to claim 11, wherein the voice recognition module compares all object names in the object name-action prompt correspondence list with the voice recognition result(s) through precise comparison or fuzzy comparison to generate the candidate object name(s).

15. The voice control device according to claim 14, wherein the action prompt output module identifies the at least one corresponding candidate action prompts corresponding to the candidate object names from the object name-action prompt correspondence list.

16. The voice control device according to claim 9, wherein the voice is a user voice.

17. A computer-readable recording medium, after read by a device, the device performing the voice control method according to claim 1.
